(19) United States
(12) Patent Application Publication
(10) Pub. No.: US 2008/0144333 A1
(43) Pub. Date: Jun. 19, 2008

(54) Laterally Light Emitting Light Guide Device

(76) Inventor: James Gourlay, Glasgow (GB)

Correspondence Address: KED & ASSOCIATES, LLP, P.O. Box 221200, Chantilly, VA, 20153-1200, US

(21) Appl. No.: 11/578,505

(22) PCT Filed: Apr. 14, 2005
(86) PCT No.: PCT/GB2005/001428

§ 371 Date: Sep. 10, 2007

(30) Foreign Application Priority Data
Apr. 15, 2004 (GB) 0408347.3

(51) Int. Cl. F21V 7/04; G02B 6/00

(52) U.S. Cl. 362/609; 362/613; 362/612; 264/1.24

(57) ABSTRACT

A light guide device and method of production can include a substrate on which are printed a number of light emitting sections and a number of light guides, the light guides being optically coupled to the light emitting sections. With this arrangement light injected at one end of the light guides is transferred to the light emitting sections where it can then exit from the device. Control of the light transferred to the light emitting sections can provide a light source with colour changing and switching capabilities that are both flexible and suitable for use in a range of static and dynamic display applications.

The present invention relates to a light guide device and in particular to a light guide device that can be used for illumination, signage or display purposes.

A number of light guide devices are known to those skilled in the art which are employed for a range of functions including illumination, signage or display purposes. These devices are generally constructed from an optical fibre that comprises a central core having a refractive index n_{c} and an outer sheath having a refractive index nₛ, chosen so that nₛ<n_{c}. The relationship between the refractive indices of the core and the sheath ensure that light is internally reflected within the core so as to propagate longitudinally along the optical fibre.

An example of such a device is described within PCT Application No. PCT/US82/01076. This document teaches of a primary light source that comprises a light guide in the form of a flexible transmission core and a translucent sleeve that is tightly fitted (e.g. by shrink fitting) around the transmission core. The translucent sleeve is designed so as to laterally disperse, diffuse or refract a substantial component of light transmitted along the core from a source at one end.

UK Patent Application No. GB 2,305,848 teaches of a visual warning device comprising a fabric in the form of an elongated strip or a garment. The fabric includes a multiplicity of strands of optical fibres, at least some of which are modified so as to divert transmitted light from a dedicated source outwardly from the sides of the strands.

A further e-ample of such devices is described in U.S. Pat. No. 5,542,016. This document teaches of an optical fibre light emitting apparatus that comprises at least one optical fibre arranged in a repeating or recurring pattern and extending substantially throughout a predetermined area. The optical fibre has a plurality of locations along its length so as to permit light entering at least one end of the optical fibre to be selectively emitted by the optical fibre at the plurality of locations. The repeating or recurring pattern may form a spiral or serpentine pattern and is shown to be beneficial for illuminating keypads and other electronic displays.

European Patent Application No. EP 0,874,191 teaches of an optical transmission tube, and a method of making the same, comprising an optical fibre as described above. A reflecting layer in the form of a strip extends between the cladding and the core and longitudinally along the cladding. As a result light passing through the core is reflected and scattered by the reflecting layer so as to exit from the fibre through an area of the outer surface of the cladding that is opposed to the reflecting layer.

Whilst illuminated light-guide devices are generally known, these known devices have only limited functionality since they are all constructed from one or more optical fibres. Furthermore, optical fibres require a high degree of skill in order to be manufactured correctly. Generally, they only allow the input of one source at each end of the optical fibre, and so they limit the shape of the light emitted to a simple line. Thus, light guide devices based on optical fibres are limited in their functionality, scalability, brightness performance and ability to be manufactured.

Alternative, illumination devices known to those skilled in the art are back lights, as typically used within liquid crystal displays (LCD). These lights employ a light source to illuminate a substrate of the LCD. However, the functionality of these devices is somewhat limited, as they can not be employed to illuminate separate areas of the substrate.

It is an object of an aspect of the present invention to provide a light guide device that exhibits increased functionality, flexibility and is simpler to produce than those devices known in the prior art.

According to a first aspect of the present invention there is provided a light guide device comprising a substrate on which are located one or more light emitting sections and one or more light guides optically coupled to the one or more light emitting sections wherein the one or more light guides provide means for transferring light to the one or more light emitting sections and the one or more light emitting sections provide an exit for the transferred light from the device.

Preferably the one or more light guides are located within a layer between the one or more light emitting sections and the substrate. Alternatively the one or more light guides are coplanar with the one or more light emitting sections.

Preferably the substrate comprises a transparent, flexible polymer material having a refractive index nₛᵤ. Similarly the one or more light guides and the one or more light emitting sections comprise transparent, flexible polymer materials having a refractive index n₁₁ and n₁₂, respectively.

Most preferably the refractive index of the substrate, the one or more light guides and the one or more light emitting layers are selected so as to satisfy the condition nₛᵤ<n₁₁≦n₁₂.

Optionally the one or more light emitting sections comprise a plurality of grooves located on the outer surface of the one or more light guides. Preferably the plurality of grooves are V-shaped.

Alternatively the one or more light emitting sections comprise a plurality of intersections between two or more sections of a light guide. In a further alternative the one or more light emitting sections comprise a plurality of bends formed within the one or more light guides.

Optionally the one or more light emitting sections further comprise a plurality of scattering particles, surface defects or structured optical surfaces for scattering the transferred light. The one or more light emitting sections may also comprise a photoluminescent material so as to alter the colour of the transferred light.

Optionally the one or more light guides comprise two or more input channels so that the light from two or more light sources can be combined for transfer to the one or more light emitting sections.

Preferably the transparent polymer material of the substrate comprises; acetate. Alternatively, transparent polymer material of the substrate comprises a material selected from the set comprising acrylic, PVC, polyester, fr4, kapton and fluoropolymers.

Preferably the transparent polymer material of the one or more light guides comprises MMA based acrylate. Alternatively, transparent polymer material of the one or more light guides comprises a material selected from the set comprising epoxies, fluoronated polymers, polyimides and transparent elastomers.

Preferably the light guide device further comprises an array of light sources suitable for coupling light into the one or more light guides.

Optionally the array of light sources comprises a plurality of light emitting diodes. Alternatively the array of light sources comprises a plurality of laser sources.

Optionally the light guide device further comprises a reflective layer located at the interface between the substrate and the one or more light guides. Alternatively the light guide device further comprises a surface structure located at the interface between the substrate and the one or more light guides. The reflective layer and surface structure is incorporated in order to enhance the proportion of light that exits the device via the light emitting layers.

Preferably the light guide device further comprises an opaque layer located on the one or more light emitting sections. Optionally the opaque layer comprises a mask. Alternatively, the opaque layer comprises a layer of ink printed on the one or more light emitting sections.

According to a second aspect of the present invention there is provided a method of producing a light guide device comprising the steps of:
1) Producing one or more light guides onto a surface of a substrate; and
2) Producing one or more light emitting sections that are optically coupled to the one or more light guides.

Optionally the method of producing a light guide device further comprises the step of forming cavities, suitable for receiving the one or more light emitting sections and/or the one or more light guides, on the surface of the substrate.

Preferably the one or more light guides are produced by a masked deposition process. Alternatively the one or more light guides are produced by a printing process. In a further alternative the one or more light guides are produced by a moulding, stamping or embossing process.

Optionally the production of the one or more light guides further comprises the step of hot blade cleaving one end of the one or more light guides.

Preferably the one or more light emitting sections are produced by a masked deposition process. Alternatively the one or more light emitting layers are produced by a printing process. In a further alternative the one or more light emitting layers are produced by a moulding, stamping or embossing process. In a yet further alternative the one or more light emitting layers are produced by physically altering the surface area of the one or more light guides.

Optionally the one or more light emitting sections are produced so that the light guides are located between the one or more light emitting sections and the substrate. Alternatively the one or more light emitting sections are produced directly onto the surface of the substrate.

Preferably the production of the one or more light emitting sections further comprises the step of depositing scattering particles within the light emitting sections.

Preferably the production of the one or more light emitting sections further comprises the step of depositing photoluminescent material within the light emitting sections.

Optionally the production of the light guide device further comprising the step of locating a means for reflecting light between the substrate and the one or more light emitting sections.

Preferably the method of producing a light guide device further comprising the step of producing an opaque layer located on the one or more light emitting sections.

Preferably the method of producing a light guide device further comprising the step of optically coupling one or more light sources to the one or more eight guides.

Aspects and advantages of the present invention will become apparent upon reading the following detailed description and upon reference to the following drawings in which:

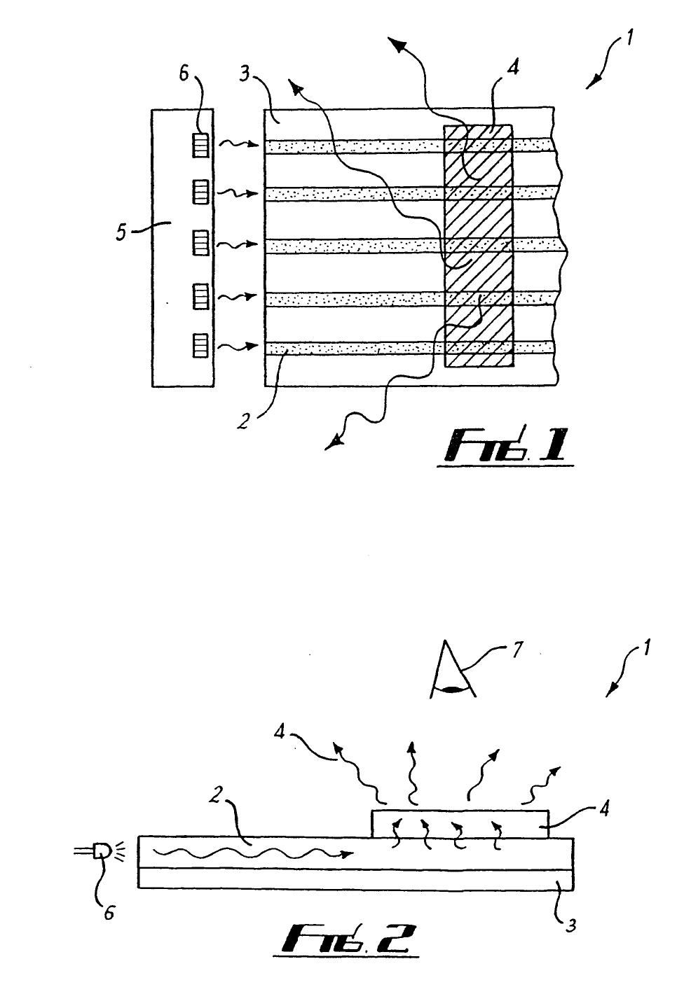

FIG. 1 presents a plan elevation of a light guide device in accordance with an aspect of the present invention;

FIG. 2 presents a side elevation of the light guide device of FIG. 1;

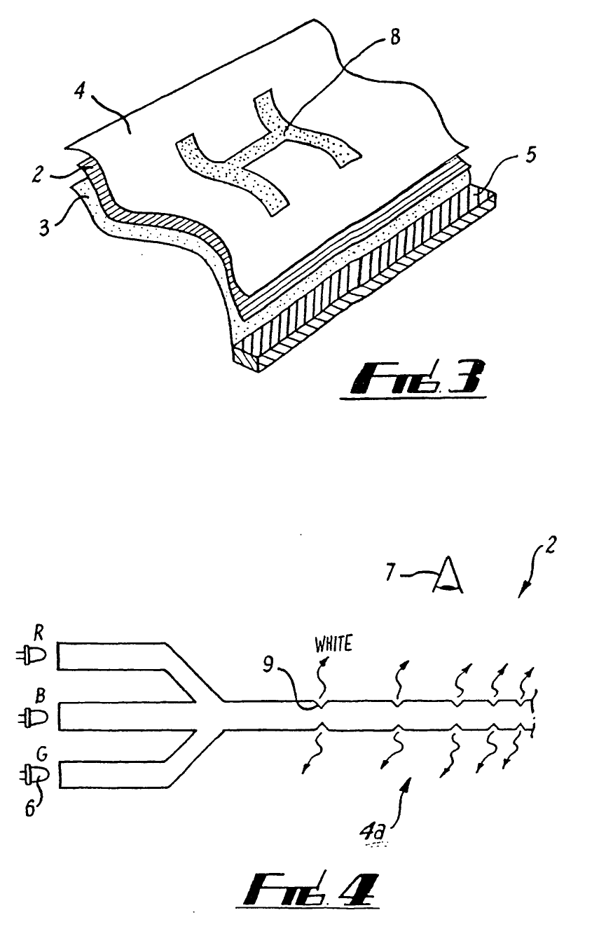

FIG. 3 presents a schematic representation of an alternative embodiment of the light guide device;

FIG. 4 presents a plan elevation of an alternative embodiment of the light guide device wherein a light emitting section comprises V-shaped grooves;

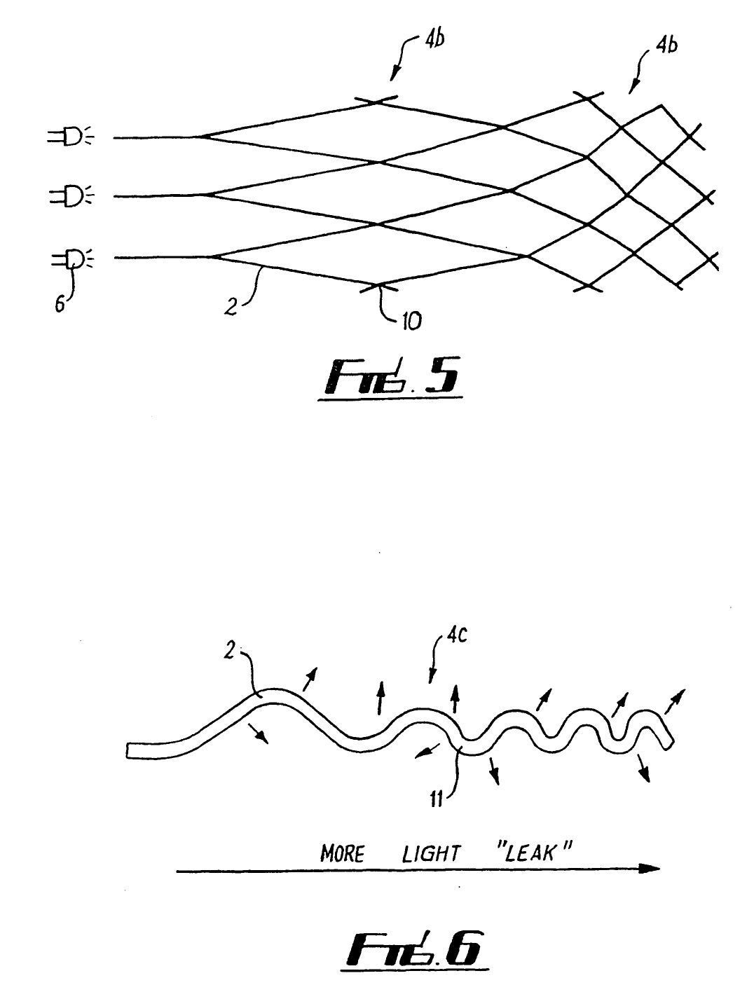

FIG. 5 presents a plan elevation of an alternative embodiment of the light guide device wherein a light emitting section comprises a criss-cross arrangement of the planar light guide; and

FIG. 6 presents a plan elevation of an alternative embodiment of the light guide device wherein a light emitting section comprises an S-shaped arrangement of the planar light guide.

Referring to FIG. 1 and FIG. 2 a plan elevation and a side elevation, respectively, of a light guide device 1 in accordance with an aspect of the present invention are presented. The light guide device 1 can be seen to comprise five planar light guides 2 that are patterned or printed onto a substrate 3, as described in detail below, and a light emitting section 4 located in a layer on top of the planar light guides 2.

FIGS. 1 and 2 also show the presence of a light source array 5. In particular the light source array 5 comprises five light emitting diodes (LED) 6 that are coupled to each of the planar light guides 2. The LEDs 6 can be of any of the designs known to those skilled in the art e.g. edge-emitting, side-emitting, top emitting or bare die LEDs.

In the preferred embodiment the substrate 3 is made from acetate, a transparent polymer material that exhibits a refractive index nₛᵤ, good mechanical flexibility and optimal wetting or adhesion properties. The planar light guides 2 are made from MMA based acrylate that is transparent to visible light, exhibits a refractive index n₁₁ and which again has good mechanical flexibility. MMA based acrylate is particularly suited for use in the light guide device 1 as it can be easily modified by changing the ratio of constituent parts, so as to optimise transmission performance, refractive index, viscosity, cure time and adhesion properties. It is these same properties that also make MMA based acrylate an ideal material for the light emitting section 4, which is designed so as to exhibit a refractive index n₁₂.

By choosing the materials for the substrate 3, the planar light guides 2 and the light emitting sections 4 such that the following condition is satisfied the operation of the device can be readily understood:

nₛᵤ<n₁₁≦n₂ (1)

The physical interpretation of the first inequality means that light injected into the planar light guides 2 is prevented from leaking into the substrate and so generally propagates along the length of planar light guides 2. As a result of the second inequality the light that propagates along the planar light guides 2 is allowed to exit the device, via the light emitting section 4, so as to be seen by an observer 7. Thus, it is the particular configuration of the light emitting sections 4 that determines the shape of the illumination to the observer 7.

Light extraction from the light emitting sections 4 is enhanced by the incorporation of a reflective layer at the interface between the substrate 3 and the planar light guides 2. This is a direct result of the fact that the reflective layer directs a higher proportion of the light propagating within the planar light guides 2 towards the observer 7. It will be appreciated by those skilled in the art that this same function can be achieved by incorporating surface structure, such as printed white dots, at the interface between the substrate 3 and the planar light guides 2 or micro-optical features, such as pyramid shapes, on top of light emitting sections.

The characteristics of the light seen by an observer 7 can be varied by printing on, patterning of and conditioning of the light emitting sections 4 and by the systematic control of the light source array 5. For example FIG. 3 presents a schematic representation of an alternative embodiment of the light guide device 1. In this embodiment a flexible H-shaped mask 8 has been located on the upper surface of the light emitting section 4. The H-shaped mask 8 is in the form of a separate substrate layer, however it can equally well be formed from ink printed directly onto the light emitting section 4.

The characteristic of the light scattered from device can be further varied by adding scattering particles, such as silica, to the planar light guides 2 or to the light emitting sections 4. Photoluminescent materials of one or more colours, such as laser dyes, phosphor particles, pigments, can also be added. In addition the surface of the planar light guides 2 or the light emitting sections 4 can be conditioned with random surface defects (e.g. sand blasting or chemical etching) or by the incorporation of structured optical surfaces (e.g. gratings, wedges or other optical structures).

FIG. 4 presents a top elevation of an alternative embodiment of the planar light guides 2 of the light guide device 1 that enables the light emitted from three LEDs 6 to be combined before propagating towards the light emitting sections 4. Thus by mixing red, green and blue LEDs 6 white light can be propagated along the planar light guide 2 to the light emitting sections 4. As will be apparent to those skilled in the art alternative coloured LEDs 6 can also be combined, as appropriate, so as to obtain white light, or any other desired colour light.

In all of the aforementioned embodiments the light emitting sections 4 are described as a distinct layer located on top of the planar light guides 2. However, in an alternative embodiment of the light guide device of FIG. 1 the light emitting section 4 is located is a single composite layer with the planar light guides 2. This embodiment involves a more complex micro-structuring production process but still exhibit the same operational parameters as the light guide device 1 described above.

Three further alternative designs the light guide device 1 that incorporate the light emitting section 4 with the planar light guides 2 are presented in FIGS. 4 to 6, respectively. As can be seen from FIG. 4, V-shaped structures 9 can be machined directly on the outer surface of the planar light guides 2 during production. It is the presence of these V-shaped structures 9 which provide the light emitting sections 4a and thus the controlled leakage of the light propagating through the planar light guides 2.

FIG. 5 presents a plan elevation of a criss-cross design of the planar light guide 2. In this embodiment it is the intersections 10 of the planar light guides 2 which provide the light emitting sections 4b and thus the controlled leakage of the propagating light from the device.

FIG. 6 presents a plan elevation of an alternatively designed planar light guide 2 that can be employed within the light guide device 1. In this embodiment S-shaped sections 11 of the planar light guide 2 define the light emitting sections 4c, the amount of light leaking from a particular S-shaped section 11 being inversely proportional to its radius of curvature.

It will be appreciated by those skilled in the art that when light propagates through a light emitting section 4 then there will be a reduction in the light left propagating along the length of the device. The printing of white ink dots onto conventional backlights to produce a uniform illumination is one known solution to those skilled in the art. However, for light emitting sections 4 of a more complex shape the determination of the uniformity compensation within the light guides 2 is non-trivial.

Within the presently described light guide device 1, this effect can be compensated for by employing one or more of the micro-structuring techniques described above in connection with the light emitting sections 4. For example, a flat uniform light source can be formed by controlled variation of the V-shaped structures 9 along the length of the planar light guide 2. By incorporating a number of these planar light guides 2, with a fine pitch a uniform illumination, as seen by the observer 7, is produced.

Alternatively, uniformity of the light output from the device can be achieved by increasing the density of intersections 10 in the direction of propagation of the light away from LED 6 light sources, see FIG. 5. In relation to the embodiment shown in FIG. 6 the same effect is achieved by gradually decreasing the radius of curvature of the S-shaped sections 11 in the direction of propagation of the light away from LED 6 light sources. It will also be appreciated by those skilled in the art that laser sources, and in particular laser diode sources, can be readily be employed within alternative embodiments of the light source array 5.

In a further alternative the angle of the light beams exiting the light emitting sections 4 towards the observer 7 can be reduced by the addition of micro-optical structures, such as pyramid shapes, so as to improve the brightness at an optimum viewing position.

Further alternative embodiments of the light guide device 1 comprise substrates 3 made from acrylic sheets, PVC, polyester, fr4, kapton or fluoropolymers. Planar light guides 2 and light emitting layers 4 made from transparent elastomers, such as eurothanes or silicones, or from off the shelf polymer UV cure optical adhesives, such as epoxies, fluoronated polymers or polyimides can also be employed in further alternative embodiments of the present invention.

### Method of Production

The light guide device 1 of the present invention is produced by the application of a printing process. In particular the planar light guides 2 are printed in predetermined patterns onto the substrate 3 by employing a negative resist process. The resist material, in the form of a polymer, is deposited in a thick film onto the substrate 3 by one of the following known processes, namely spin coating, dip coating, doctor blading or spraying. A positive mask, containing a pattern of the required planar light guides 2 is then used within a proximity or contact printing process so as to cross-link the resist material. A collimated UV light source with a high aspect ratio, an UV laser source or e-beam writing can all be used for this stage of the process. The negative resist process can then be repeated so as to produce the required light emitting sections 4.

The next stage in the process involves the coupling of the LEDs 6 of the light source array 5 to the planar light guides 2. This is achieved by a butt coupling process where the LEDs 6 are attached to the end of the planar light guides 2 by UV curing with a high refractive index photonic adhesive (e.g. epoxy or acrylate) that acts to reduce reflections from the ends of the planar light guides 2. The end of the planar light guides 2 are then hot blade cleaved to provide a good optical surface at: the end of the light guide facilitating good coupling of light from the source into the light guide.

It will be obvious to those skilled in the art that a positive resist material and a negative mask may equally well be used for She production of the light guide devices 1.

Other alternative methods for producing the light guide devices 1 may also be employed. For example the planar light guides 2 and/or the light emitting sections 4 can be formed by screen printing. An optical UV curing polymer or negative resist with the correct rheology/viscocity for matching the mesh density of the screen is used. The optical polymer is screen printed onto the substrate 3 and then snap cured with UV light.

In another alternative method the planar light guides 2 and/or the light emitting sections 4 are formed by moulding, stamping or embossing on the substrate 3. The master for the moulding, stamping or embossing process is produced by one or more of the methods described above.

In a yet further alternative method the planar light guides 2 and/or the light emitting sections 4 are formed by a needle dispensing robot. The robot moves a needle dispense unit across the substrate 3 through a pre-programmed route and material is thus transferred to the substrate 3 in a controlled manner. In this way, long thin polymer planar light guides 2 can be formed on the surface. The polymer can be cross-linked by thermal or UV methods.

A further method of patterning the light-guides 2 and/or the light emitting sections 4 is to print a high surface energy ink onto the substrate 3 which then acts to constrain the flow of the polymer material before the curing process takes place.

Patterning of the polymer for the light guides 2 and/or light emitting sections 4 can also be achieved by the cutting of cavities within a sheet of material on the substrate 3. The polymer can then be cast or screened directly into these cavities. The sheet of material from which the cavities are cut is chosen so as to be of a lower refractive index than the polymer and/or a highly reflecting or light blocking material.

A final alternative method of production involves the planar light guides 2 and/or the light emitting layers 4 being formed by ink jet printing.

It should be noted that the above methods for producing the planar light guides 2 and the light emitting sections 4 can be readily combined. Thus, the light emitting sections 4 can be formed by direct machining, rolling, hot embossing, UV embossing, micro-structuring, sand blasting, chemical etching of the planar light guides 2.

Other alternative methods for coupling the LEDs 6 of the light source array 5 to the planar light guides 2 may also be employed. For example the LEDs 6 can be coupled to the planar light guides 2 by passive or active alignment techniques. This is achieved through the mechanical alignment of a ball lens so as to transfer the light from an LED 6 to a planar light-guide 2.

In another alternative coupling method the LEDs 6 are coupled to the planar light guides 2 by having the planar light guides 2′ written directly onto micro-packaged or bare-die LEDs.

A yet further alternative coupling method involves the LEDs 6 being coupled to the planar light guides 2 by tapered light guide coupling. This method allows for more light to be gathered from the LEDs 6 and also improves mechanical tolerances of the device.

Alternatively, the LEDs 6 are coupled to the planar light guides 2 by a 90-degree coupling with microstructure process. This is achieved by attaching a grating or refractive structure, such as a collimating lens and beam redirection with micro-wedge, to the planar light guides 2. Typically, hot embossing, UV embossing, or lithography techniques directly attach these structures onto the planar light guides 2 or to the light emitting sections 4.

As a further option the LEDs 6 can be coupled to the planar light guides 2 by employing custom or modified LED lens/packages. For example, a slot machined into standard dome lens package allows a planar light guide 2 on the substrate to be mechanically coupled to an LED 6.

Yet further options for coupling the LEDs 6 to the planar light guides 2 involves coupling them directly on an electronic module or by employing a manufactured optical component.

The above methods can be employed to manufacture large rolls of the light guide device. These can then be cut to size as and when required and thereafter coupled in situ to light source arrays, as appropriate.

From the above description it can be readily seen that the light guide device of the present invention allows the separate and individual illumination of a plurality of areas on a substrate, each area with individual control of light from one or more light sources. The functionality of the device can therefore be employed within a range of applications. For example the device can be employed so as to form patterned and functional illuminated areas, such as animated back lights for use behind printed company logos and brands. The systematic control of the light source array provides these back lights with colour changing and switching capabilities that is both flexible and suitable for static/dynamic display applications.

Another application of the light guide device is within the production of illuminated keypads and keyboards. The light-guides can be manufactured above or below the keypad or keyboard structures to allow these to appear independently illuminated to an observer. Colour changing functionality can therefore be directly applied to the keys keypads or keyboards. In particular, this light-guide solution is well suited to tactile keypads, which are printed and laminated on flexible polymer sheets.

A further application of the light guide device is in the production of illuminated functional signage letters and block or half-tone picture areas that can be illuminated and/or animated by a number of light sources. The flexible nature of the light guide device provides the advantage that the device can be used to allow portable and temporary signage/promotion, roll-up and/or inflatable illuminated structures.

A yet further application of the light guide device is that it can be used to enable, clothing with “leaky” light guide structures “attached” to clothing items. Illuminated safety clothing and branding opportunities are therefore obvious further applications of the device.

The foregoing description of the invention has been presented for purposes of illustration and description and is not intended to be exhaustive or to limit the invention to the precise form disclosed. The described embodiments were chosen and described in order to best explain the principles of the invention and its practical application to thereby enable others skilled in the art to best utilise the invention in various embodiments and with various modifications as are suited to the particular use contemplated. Therefore, further modifications or improvements may be incorporated without departing from the scope of the invention as defined by the appended claims.

1-36. (canceled)

37. A light guide device comprising a substrate having a first surface on which are located one or more light emitting sections and one or more light guides, the one or more light emitting sections being optically coupled to the one or more light guides, wherein the one or more light emitting sections provide one or more exits for light from the device that are directed away from the first surface, wherein the one or more light emitting sections are laterally optically coupled to the one or more light guides on the first surface such that the one or more light emitting sections and the one or more light guides are coplanar on the first surface.

38. A light guide device as claimed in claim 37, wherein the substrate comprises a transparent, flexible polymer material having a refractive index nₛᵤ.

39. A light guide device as claimed in claim 37, wherein the one or more light guides comprise a transparent, flexible polymer material having a refractive index n₁₁.

40. A light guide device as claimed in claim 37, wherein the one or more light emitting sections comprise a transparent, flexible polymer material having a refractive index n₁₂.

41. A light guide device as claimed in claim 40, wherein a refractive index of the substrate, the one or more light guides and the one or more light emitting layers are selected so as to satisfy the condition nₛᵤ<n₁₁≦n₁₂.

42. A light guide device as claimed in claim 37, wherein the one or more light guides comprise a plurality of grooves located on the outer surface of the one or more light guides so as to optically couple the one or more light guides to the one or more light emitting sections.

43. A light guide device as claimed in claim 42, wherein the plurality of grooves are V-shaped.

44. A light guide device as claimed in claim 37, wherein the one or more light guides comprise a plurality of intersections between two or more sections of a light guide so as to optically couple the one or more light guides to the one or more light emitting sections.

45. A light guide device as claimed in claim 37, wherein the one or more light guides comprise a plurality of bends so as to optically couple the one or more light guides to the one or more light emitting sections.

46. A light guide device as claimed in claim 37, wherein the one or more light guides comprise a plurality of scattering particles, surface defects or structured optical surfaces for scattering the transferred light so as to optically couple the one or more light guides to the one or more light emitting sections.

47. A light guide device as claimed in claim 37, wherein the one or more light emitting sections comprise a photoluminescent material so as to alter the colour of light optically coupled into the one or more light emitting sections.

48. A light guide device as claimed in claim 37, wherein the one or more light guides comprise two or more input channels so that the light from two or more light sources can be combined for transfer to the one or more light emitting sections.

49. A light guide device as claimed in claim 38, wherein the transparent polymer material of the substrate comprises a material selected from the set comprising acetate, acrylic, PVC, polyester, fr4, kapton and fluoropolymers.

50. A light guide device as claimed in claim 39, wherein the transparent polymer material of the one or more light guides comprises a material selected from the set comprising MMA based acrylate, epoxies, fluoronated polymers, polyimides and transparent elastomers.

51. A light guide device as claimed in claim 37, wherein the light guide device further comprises an array of light sources suitable for coupling light into the one or more light guides.

52. A light guide device as claimed in claim 51, wherein the array of light sources comprises one or more light emitting diodes.

53. A light guide device as claimed in claim 51, wherein the array of light sources comprises one or more laser sources.

54. A light guide device as claimed in claim 37, wherein the light guide device further comprises a reflective layer located at the interface between the substrate and the one or more light emitting sections.

55. A light guide device as claimed in claim 37, wherein the light guide device further comprises a surface structure located at the interface between the substrate and the one or more light emitting sections.

56. A light guide device as claimed in claim 37, wherein the light guide device further comprises an opaque layer located on the one or more light emitting sections.

57. A light guide device as claimed in claim 56, wherein the opaque layer comprises a mask.

58. A light guide device as claimed in claim 56, wherein the opaque layer comprises a layer of ink printed on the one or more light emitting layers.

59. A method of producing a light guide device comprising:
producing one or more light guides on a first surface of a substrate; and
producing one or more light emitting sections on the first surface of the substrate, the light emitting sections being optically coupled to the one or more light guides and arranged to provide one or more exits for light from the device that are directed away from the first surface; wherein the one or more light emitting sections are produced to be laterally optically coupled to the one or more light guides on the first surface such that the one or more light emitting sections and the one or more light guides are coplanar on the first surface.

60. A method of producing a light guide device as claimed in claim 59, wherein the one or more light guides are produced by a masked deposition process, a printing process or a moulding, stamping or embossing process.

61. A method of producing a light guide device as claimed in claim 59, wherein the production of the one or more light guides further comprises the step of hot blade cleaving one end of the one or more light guides.

62. A method of producing a light guide device as claimed in claim 59, wherein the one or more light emitting sections are produced by a masked deposition process, a printing process or a moulding, stamping or embossing process.

63. A method of producing a light guide device as claimed in claim 59, wherein the optical coupling of the one or more light guides to the one or more light emitting sections is produced by physically altering the surface area of the one or more light guides.

64. A method of producing a light guide device as claimed in claim 59, wherein the optical coupling of the one or more light guides to the one or more light emitting sections is produced by depositing scattering particles within the light guides.

65. A method of producing a light guide device as claimed in claim 59, wherein the production of the one or more light emitting sections comprises depositing photoluminescent material within the light emitting sections.

66. A method of producing a light guide device as claimed in claim 59, the method further comprising locating a means for reflecting light between the substrate and the one or more light emitting sections.

67. A method of producing a light guide device as claimed in claim 59, the method further comprising producing an opaque layer located on the one or more light emitting sections.

68. A method of producing a light guide device as claimed in claim 59, the method further comprising optically coupling one or more light sources to the one or more light guides.
